(19) United States
(12) Patent Application Publication
(10) Pub. No.: US 2004/0070282 A1
(43) Pub. Date: Apr. 15, 2004

(54) Sensor arrangement with wirelessly-connected units and clamping device with one such sensor arrangement

(76) Inventors: Remy Kirchdoerffer, Reichshoffen (FR); Ralf Schmidt, Freinsheim (DE)

Correspondence Address: YOUNG & THOMPSON, 745 SOUTH 23RD STREET 2ND FLOOR, ARLINGTON, VA, 22202

(21) Appl. No.: 10/417,250

(22) Filed: Apr. 17, 2003

(30) Foreign Application Priority Data
Apr. 17, 2002 (EP) 02360124.8

(51) Int. Cl. H02H 3/42; H01H 83/18

(52) U.S. Cl. 307/126

(57) ABSTRACT

The invention relates to a sensor arrangement, for example for determining the position and/or motion of an element or part which has at least one sensor unit and an electronic supply and receiving unit, the two units being accommodated in housings which are independent of one another, characterized in that the energy for operating at least one sensor unit (3, 3′) is transmitted between the housings (5 and 6) by magnetic induction, the housing (6) of the supply and receiving unit (4) containing a primary coil (7) which is electrically connected to the latter, the housing (5) of at least one sensor unit (3, 3′) containing a secondary coil (8) which is electrically connected to the latter, of a thus jointly formed transformer (7 and 8), and that the sensor states are transmitted by means of wireless transmission to the supply and receiving unit (4).

This invention relates to the area of scanning and detection of the position and optionally the motion of an article which influences for example electromagnetic fields, and relates to a sensor arrangement with wirelessly connected units, and a clamping device which has one such sensor arrangement.

Various sensor types are known which are able to detect the position or motion of an element.

In particular, sensors are known which work according to the inductive and capacitive principle and usually have LC tuned circuits, the coil “L” being turned toward the active surface, and it can be influenced in its properties by an external influencing, especially attenuating, for example, metallic element.

The LC tuned circuit forms an oscillating system which oscillates automatically at a certain frequency. By influencing the coil, free oscillation conditions are no longer present so that the oscillation attenuates or stalls until the attenuating element is removed or eliminated and the oscillator can continue to oscillate again or can build up.

Sensors of this type are known especially from EP applications No. 1440262.2, No. 01440311.7 and No. 01440399.2.

There are application circumstances and conditions in which, for example, for reasons of space, installation and/or configuration, the sensor arrangement must be divided into at least two physically separated component systems, specifically a base housing and at least one satellite housing.

The base housing then contains the evaluation electronics and has connecting means (plugs) for power supply and signal transmission to the outside.

The satellite housing or housings contain the sensor units.

These sensor units can be accommodated either as individual sensors in various housings or as a double sensor in one housing, the two LC systems being located at a fixed distance.

In both cases the two housings are connected by cables.

Adjustable systems with cabled satellites moreover require a mechanical support on which the base housing and the satellite or satellites can be mounted and adjusted.

The application always makes it difficult to lay the two cables such that

a) they are not damaged and

b) at least one of the satellites remains adjustable in order to set the operating point.

c) upon damage the replacement of the complete system (sensors+evaluation) must always be possible.

Moreover installation, and thus also the calibration of the operating point, are complex.

The object of the invention is to eliminate the aforementioned disadvantages of the prior art.

Thus the invention relates to a sensor arrangement, for example for determining the position and/or motion of an element or part which has at least one sensor unit and an electronic supply and receiving unit, the two units being accommodated in housings which are independent of one another.

This sensor arrangement is characterized in that the energy for operating at least one sensor unit is transmitted between the housings by magnetic induction, the housing of the supply and receiving unit containing the primary coil connected to the electrical supply, and the housing of at least one sensor unit containing a secondary coil, which is electrically connected to it, of a thus jointly formed transformer, and that the sensor states are transmitted by means of wireless transmission to the supply and receiving unit.

In fact, a completely wireless connection or transmission between the units solves all the aforementioned problems by their allowing simple calibration, good operating reliability and thus also extremely low installation and maintenance times.

It goes without saying that the invention is used both in sensor arrangements with one sensor unit and also sensor arrangements with several sensor units.

Preferably the inventive sensor arrangement contains at least two satellite-like sensor units which are both accommodated in the same housing (or in different housings) and are made as proximity switches which work according to the inductive principle, the movable element or part to be detected consisting at least partially of a material which influences magnetic fields.

According to a first version of the invention, the sensor states are transferred to the supply and receiving unit preferably by inductive or capacitive coupling or feedback.

According to a second version of the invention, the sensor states are transferred to the supply and receiving unit via direct or indirect electrical contacts between the two housings.

The two housing can be equipped for example with contact clips.

According to a third version of the invention the sensor states are transferred to the supply and receiving unit in optical form after a corresponding optical signal has been prepared.

Following one preferred execution of the invention, each sensor unit is made as a LC tuned circuit and the state of each sensor is determined based on its power consumption, since the power consumption of the sensors in the oscillating state is greater than in the non-oscillating state (for example after the oscillation has stalled).

The sensor units however can also optionally be made such that they execute analog detection.

The installation of the sensor units in their common housing can be made such that the sensor unit or at least one of the sensor units is adjustably located at least along one translation direction and/or at least around one axis of rotation, optionally depending on the possibilities of motion of the part or element which is to be detected.

In order to protect the sensor units from external influences (impact, shock, collision, pressure, dirt, . . . ) and to connect them rigidly to the application, as claimed in the invention it can be provided that the housing of the sensor unit(s), especially at least partially, preferably entirely, is integrated securely into the housing or the structure of the device which has the movable part or element which is to be detected, the housing of the supply and receiving unit being mounted on the outside of this housing or this structure, preferably in an easily removable manner.

According to one advantageous practical execution of the invention, the supply and receiving unit contains the following components which form the basic electronics:

an electronic circuit for driving the transformer,

an electronic circuit for receiving the sensor states,

switching amplifier and/or bus terminal circuits downstream of the receiving electronics,

connecting means, especially plug connecting means, for connection of the supply and receiving unit to a supply and to any installed electronics which further process signals.

The invention also relates to a clamping device which contains a movable element or part, such as for example a piston rod, with a position which depends on the closed and open state of the clamping device, characterized in that it has a sensor arrangement as claimed in the invention which contains at least two satellite or sensor units which are located spaced along one axis which extends parallel to the direction of motion of the movable part or element.

The determination of the position of the movable part or element can take place optionally in an analog manner.

In the following description the invention is detailed using embodiments, in conjunction with the attached schematic figures.

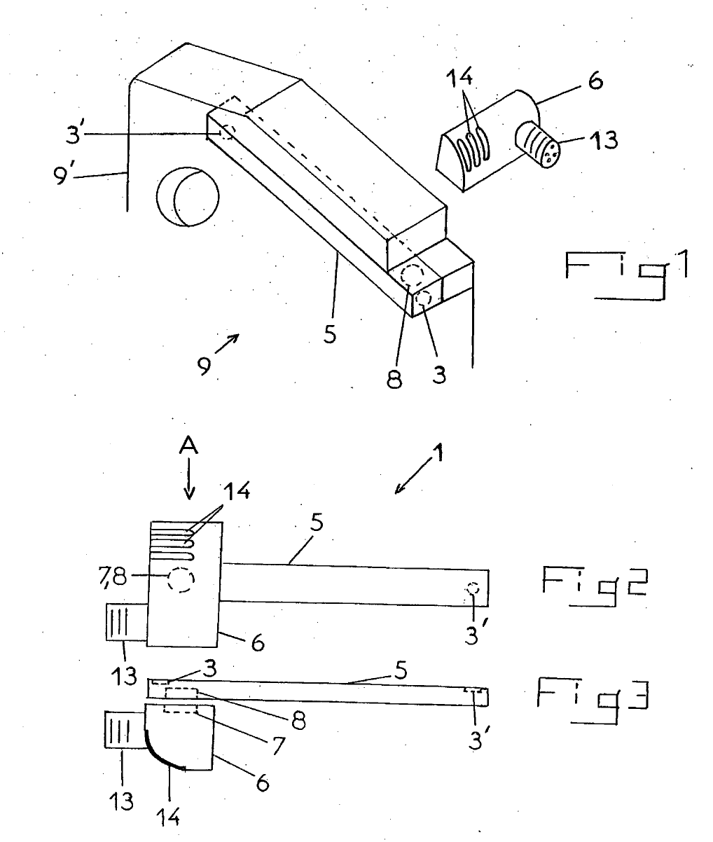

FIG. 1 shows a perspective partial view of a clamp gripper part with a sensor arrangement as claimed in the invention;

FIG. 2 shows an overhead view of a sensor arrangement as claimed in the invention;

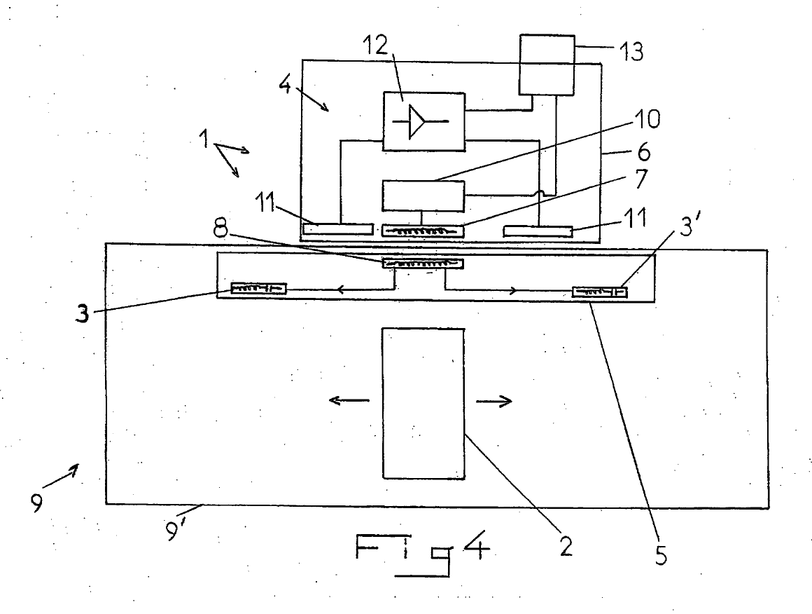

FIG. 3 shows a view in the direction A of the sensor arrangement of FIG. 2;

FIG. 4 shows a schematic of one sensor arrangement as claimed in the invention.

The sensor arrangement 1 of FIGS. 1, 2, 3, and 4 has two sensor units 3 and 3′ made as satellites and a supply and receiving unit 4 which also contains the primary evaluation electronics.

The illustrated satellite-like sensor units 3 and 3′ work preferably using an inductive detection principle and are accommodated in a common housing 5.

The electronic unit 4 (hereinafter also called the evaluation electronics or basic electronics) is accommodated in a second, separate housing 6.

The energy for operating at least one sensor unit 3, 3′ is transmitted by magnetic induction, the housing 6 of the supply and receiving unit 4 containing a primary coil 7 and the housing 5 of at least one sensor unit 3, 3′ containing a secondary coil 8 which feeds the latter, of a jointly formed transformer 7 and 8, and the sensor states are transmitted by means of wireless transmission to the supply and receiving unit 4.

The two sensor units 3 and 3′ can have either fixed sensing surfaces or sensing surfaces which are adjustable or variable in their positions (which bear the flat coil of the LC tuned circuit).

This sensor housing 5 can however also contain sensors which execute analog detection of the moving part or element 2.

Since there is no cable connection between the sensor housing or housings 5 and the evaluation electronics housing 6, the energy for operating the sensor units 3 and 3′ is transmitted by a transformer in which the primary coil 7 is integrated into the housing 6 of the evaluation electronics, and the secondary coil 8 of the transformer, or is contained in the sensor housing(s) 5.

The sensor states are transmitted either inductively, capacitively, optically or via electrical contacts back to the receiving and evaluation electronics in the base housing 6.

The sensor housing 5 can be integrated permanently into the application—for example a tension jack—without consideration of ease of replacement because damage can only occur on the cable connection to the evaluation electronics or to its housing, as claimed in the invention.

By magnetic induction dictated by:

the electrical dimensioning

the mechanical arrangement of the primary transformer coil 7 in the base housing 6 and

the mechanical arrangement of the secondary transformer coil 8 in the sensor or satellite housing 5, power is transmitted into the secondary coil 8 and makes available roughly 30 mW per satellite or sensor unit 3, 3′ for supplying a conventional LC tuned circuit, as is conventional in inductive proximity switches.

Each of these LC tuned circuits changes its power demand depending on the presence or position of an existing actuation element (BE) 2. In most cases the tuned circuit of each sensor unit is balanced such that the oscillation stalls when the actuation element 2 falls below a certain distance (operating distance).

Then, for example, a higher power supply current flows oscillating than not oscillating (<3mA;>1mA).

These two states can be inductively indicated by for example each satellite 3, 3′ with a different frequency reporting its oscillation state to the base electronics, or by the load which each satellite 3, 3′ represents on the transformer 7, 8, being detected in the receiving and evaluation electronics 4.

The indication can however also take place optically, each satellite driving a LED which then goes out or changes its frequency with the oscillation state of the corresponding LC tuned circuit.

The light of the LEDs can be transmitted for example by a covering as an optical fiber from the pertinent satellites 3, 3′ to one receiver at a time in the base housing 6 so that in all cases the receiving and evaluation electronics can form a closed unit (4 in 6), like the satellites (3, 3′ in 5).

The coils 7 and 8 can preferably be made as space-saving, flat disk coils opposite one another (see FIGS. 2 and 3).

As proceeds in part from FIG. 1 and FIG. 4, the invention also relates to a clamping device (for example, toggle lever clamping device or cam chuck gripper) in which the position of a piston rod can be detected such:

that the sensor units 3, 3′ for detecting the position are accommodated in a separate housing 5 and are supplied with power without a cable connection,

that the position of the piston rod (as element 2) is likewise transmitted without a cable connection to electronics (receiving and evaluation electronics) which carry out further processing,

that the sensor housing 5 is structurally integrated into the housing 9′ of the clamping device 9, from the outside no especially slotted openings being necessary;

that all surfaces of the clamping device 9 are available for its mounting and

that the clamping device 9 need not be dismounted to replace the supply and receiving unit 4 (including the evaluation electronics).

In the primary evaluation electronics which are integrated in the housing 6 or optionally in the downstream and installed evaluation electronics, different operating parameters can be determined, such as the closing and opening speed of the jack 9, acceleration, number of closing cycles and similar parameters, so that an error signal can be generated when departing from a given tolerance boundary.

In the housing 6 which holds the base electronics (supply and receiving unit 4, and possible primary evaluation electronics), the following in particular are located:

electronics 10 for driving the transformer 6, 7;

receiving electronics 11 for receiving and for recording the sensor states;

the (two) switching amplifiers 12 or the bus interface and

the plug 13 for connection to a voltage supply and electronics which carry out further processing,

local display means 14 which for example indicate the operating state and/or the general state of the sensor arrangement.

Since only this electric unit 4 can be damaged by external influences, only these electronics which are very easy to remove and mount need be replaced.

For comparable known approaches, see for example DE 196 16 441 C1, in order to replace the electronics, the clamping device must be dismounted, especially when it is mounted from the back.

Due to the absence of any connecting cables in the sensor arrangement as claimed in the invention, thus:

installation times,

maintenance times and

damage probabilities are minimized.

The housing 5 which contains the secondary coil 7 and the sensor units 3 and 3′ thus forms a closed sensor cassette which can be produced beforehand as a unit and can be integrated into the application, in the production of this application.

Of course the invention is not limited to the described embodiments. Changes, for example, in the embodiments of the different components or replacement by the technical equivalent, are possible at any time if they remain within the framework of the claimed patent.

1) Sensor arrangement, for example for determining the position and/or motion of an element or part which has at least one sensor unit and an electronic supply and receiving unit, the two units being accommodated in housings which are independent of one another, characterized in that the energy for operating at least one sensor unit (3, 3′) is transmitted between the housings (5 and 6) by magnetic induction, the housing (5) of the supply and receiving unit (4) containing a primary coil (7), and the housing (6) of at least one sensor unit (3, 3′) containing a secondary coil (8) of a thus jointly formed transformer (7 and 8), and that the sensor states are transmitted by means of wireless transmission to the supply and receiving unit (4).

2) Sensor arrangement as claimed in claim 1, wherein it contains satellite-like sensor units (3 and 3′) which are accommodated in the same housing (5) and are made as proximity switches which work according to the inductive principle, the movable element or part (2) to be detected consisting at least partially of a material which influences magnetic fields.

3) Sensor arrangement as claimed in claim 1 or 2, wherein the sensor states are transferred to the supply and receiving unit (4) without contact, preferably by inductive or capacitive coupling or feedback.

4) Sensor arrangement as claimed in claim 1 or 2, wherein the sensor states are transferred to the supply and receiving unit (4) via direct or indirect electrical contacts between the two housings (5 and 6).

5) Sensor arrangement as claimed in claim 1 or 2, wherein the sensor states are transferred to the supply and receiving unit (4) in optical form.

6) Sensor arrangement as claimed in one of claims 1 to 5, wherein each sensor unit (3, 3′) is made as a LC tuned circuit and wherein the state of each sensor (3, 3′) is determined based on its power consumption.

7) Sensor arrangement as claimed in one of claims 1 to 6, wherein the sensor unit or at least one of the sensor units (3, 3′) is adjustably located at least along one translation direction and/or at least around one axis of rotation, optionally depending on the possibilities of motion of the part or element (2) which is to be detected.

8) Sensor arrangement as claimed in one of claims 1 to 7, wherein the housing (5) of the sensor unit(s) (3, 3′), at least partially, preferably entirely, is integrated securely into the housing or the structure (9′) of the device (9) which has the movable part or element (2) which is to be detected, the housing (6) of the supply and receiving unit (4) being mounted on the outside of this housing or this structure (9′), preferably in an easily removable manner.

9) Sensor arrangement as claimed in one of claims 1 to 8, wherein the supply and receiving unit (4) contains the following components which form the basic electronics:
an electronic circuit (10) for driving the transformer (7 and 8),
an electronic circuit (11) for receiving the sensor states,
switching amplifier and/or bus terminal circuits (12) downstream of the receiving electronics,
connecting means (13), especially plug connecting means, for connection of the supply and receiving unit (4) to a power supply and to any installed electronics which further process signals.

10) Clamping device which contains a movable element or part, such as for example a piston rod, with a position which depends on the closed and open state of the clamping device, characterized in that it has a sensor arrangement (1) as claimed in the one of claims 1 to 9, which contains at least two satellite or sensor units (3 and 3′) which are located spaced along one axis which extends parallel to the direction of motion of the movable part or element (2).
